(19) United States
(12) Patent Application Publication
(10) Pub. No.: US 2007/0223761 A1
(43) Pub. Date: Sep. 27, 2007

(54) Personal Portable Speaker Assembly

(76) Inventor: Eagle Fan, Chu-Pei City (TW)

Correspondence Address: LIN & ASSOCIATES INTELLECTUAL PROPERTY, P.O. BOX 2339, SARATOGA, CA, 95070-0339, US

(21) Appl. No.: 11/419,761

(22) Filed: May 23, 2006

Related U.S. Application Data
(63) Continuation-in-part of application No. 11/367,898, filed on Mar. 3, 2006.

(51) Int. Cl. H04R 1/02; H04R 5/02; H04R 9/06

(52) U.S. Cl. 381/334; 381/301; 381/388

(57) ABSTRACT

A personal speaker assembly is provided, including a wire connected between a plug and at least one speaker wherein the plug is connected with a music player. The wire is in a loop form so as to be mounted on the user's neck and the at least one speaker is arranged to be approximate to the user's ear so that the user can enjoy the music while the sound outside can be heard.

### CROSS-REFERENCES TO RELATED APPLICATIONS

This is a continuation-in-part of U.S. application Ser. No. 11/367,898, filed Mar. 3, 2006.

### FIELD OF THE INVENTION

The present invention relates to a personal music speaker assembly with two speakers connected to a loop which includes a plug connected with a music player. The loop is mounted on the user's neck and the speakers are located close to the use's ears.

### BACKGROUND OF THE INVENTION

Along with the develop of compact music players, users can carry of music player conveniently without occupying too much space and the modern music players can store hundreds of songs so that the users can enjoy the music a using an ear set. Generally, the ear set includes a plug which is electrically connected with the music player and two ear phones which are inserted in the ears so that music can be brought into the user's ears with a very high quality of sound. However, there is a potential shortcoming if listening music by the ear set for a longer period of time, which is that the ears could be hurt by the close and loud voice from the ear phones. Besides, because the ear phones fill the ears so that the user cannot hear sound from outside, which affects the user's reaction.

The present invention intends to provide a personal speaker assembly wherein the speakers are not positioned in the user's ears and the assembly can mounted on the user's neck and arrange the speakers to be proximate to the ears.

### SUMMARY OF THE INVENTION

The present invention has been made to overcome the above-mentioned drawback of conventional speaker earphones. The primary object of the present invention is to provide a personal speaker assembly that can be placed below the user's ears to avoid the sound blocking effects of a conventional earphone.

Another object of the present invention is to provide a personal speaker assembly that can be hidden in a scarf so that the scarf can also play music while keeping the user warm in winter.

Yet another object of the present invention is to provide a personal speaker assembly that can be bended into any form to wrap around body parts, other objects or stand alone on any surface.

To achieve the above objects, the present invention provides a personal speaker assembly including a plug connected to a wire which is electrically connected at least one speaker. The wire can be mounted on a use's neck and the at least one speaker is located beneath the user's ear. The plug is connected with a music player so that the music can be heard by the user from the at least one speaker while the user's ear can also hear outside sound.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows the speaker assembly of the present invention;

FIG. 2 shows that the speaker assembly of the present invention is mounted on the user's neck;

FIG. 3 shows second embodiment of the speaker assembly of the present invention;

FIG. 4 shows a third embodiment of the speaker assembly of the present invention;

FIG. 5 shows a user uses the third embodiment of the speaker assembly of the present invention;

FIG. 6 shows a fourth embodiment of the speaker assembly of the present invention;

FIG. 7A shows a fifth embodiment of the speaker assembly of the present invention;

FIG. 7B shows a cross-sectional view of the connector of the fifth embodiment of the present invention;

FIG. 8 shows a schematic view of the application of the fifth embodiment of the present invention on human body; and

FIG. 9 shows a schematic view of the application of the fifth embodiment of the present invention standing alone on a desk.

### DETAILED DESCRIPTION OF THE PREFERRED EMBODIMENTS

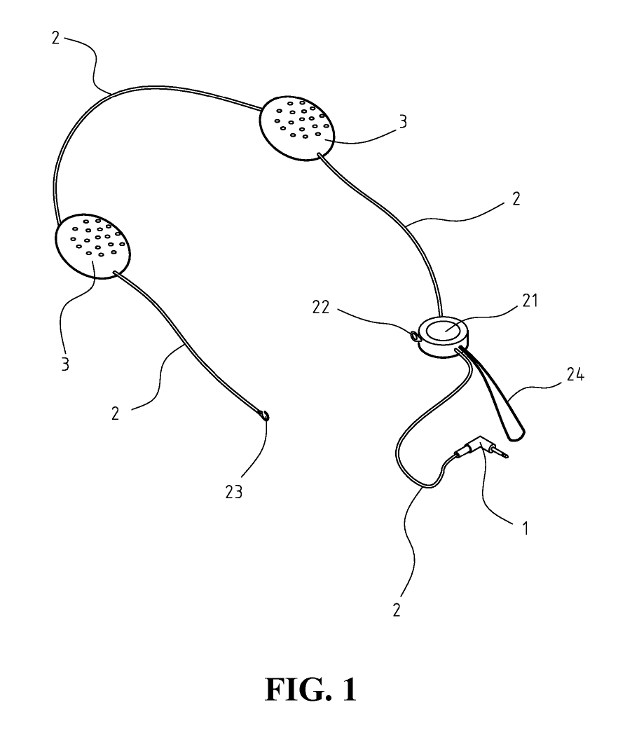

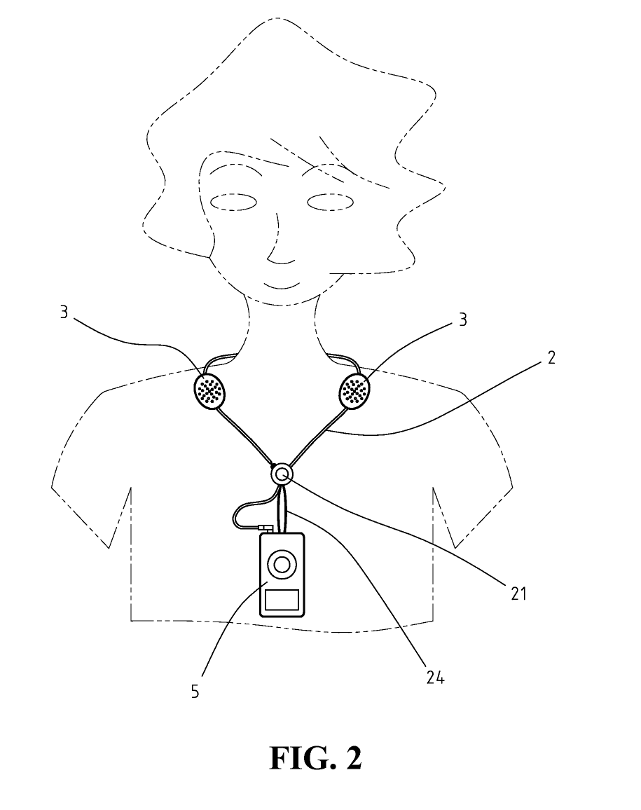

With reference to the drawings and in particular to FIGS. 1 and 2, the speaker assembly of the present invention a plug 1 connected to a first end of a wire 2 and the other end of the wire 2 is connected to two speakers 3. The plug 1 can be used with a music player such as CD player, MP3 player, cassette player or radio. The wire 2 includes electrical wires which are connected to the plug 1 and the speakers 3.

The wire 2 has a connection member 21 connected thereto and a first connection end 22 is connected to the connection member 21. A remote end of the wire 2 has a second connection end 23 which is connected with the first connection end 22 so as to form a loop which can be mounted on the user's neck. The plug 1 extends from the loop and is connected to a music player 5 which is connected to a hanging loop 24 on the connection member 21. The two speakers 3 are located beneath the user's ears so that the user can hear the music.

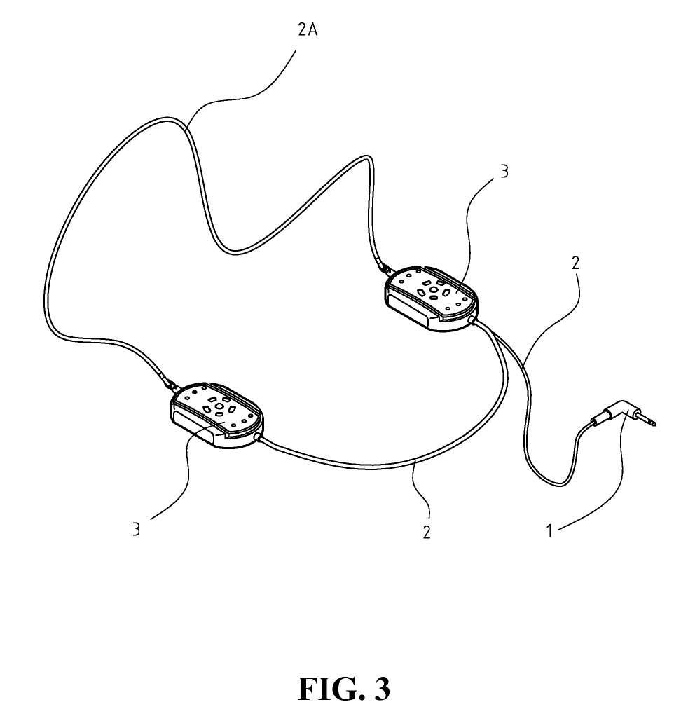

FIG. 3 shows a second embodiment of the speaker assembly of the present invention, wherein the wire 2 is connected between the two speakers 3 and the plug 1 is extended from the wire 2. A strip 2A is connected to the two speakers 3 such that the strip 2A and the wire 2 form a loop.

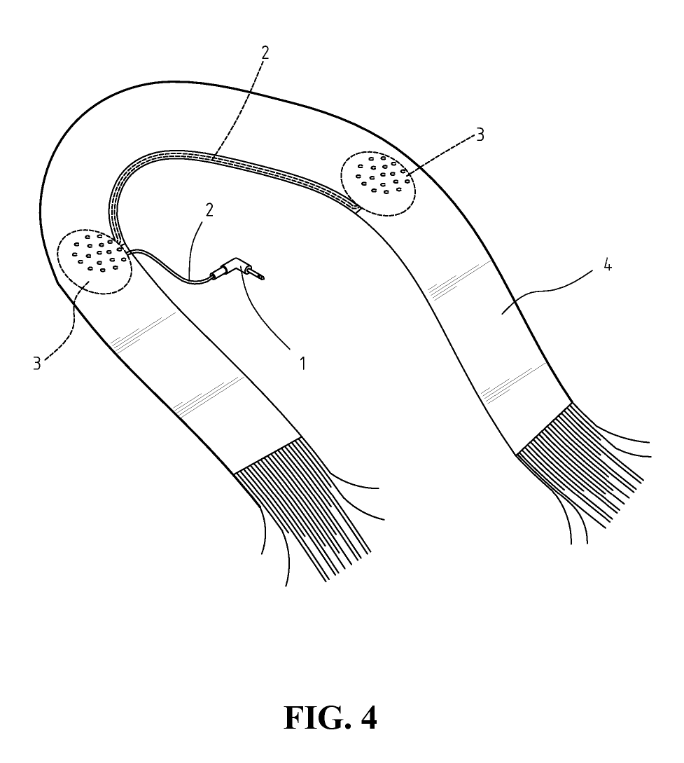

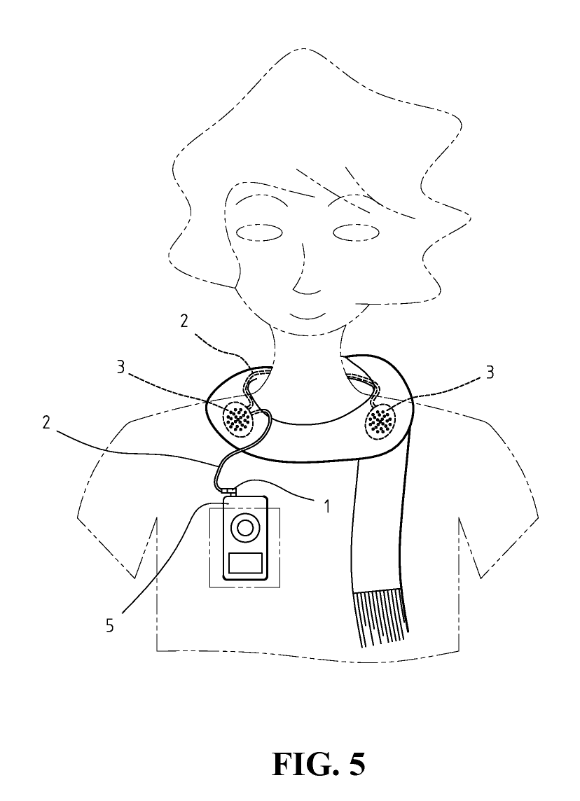

FIGS. 4 and 5 show a third embodiment of the speaker assembly of the present invention, wherein the wire 2 and the speakers 3 are received in a scarf 4. The wire 2 and the speakers 3 are enclosed and hidden by the scarf 4. The plug 1 and a section of the wire 2 extend out from the scarf 4 so as to be connected with the music player 5 as shown in FIG. 5.

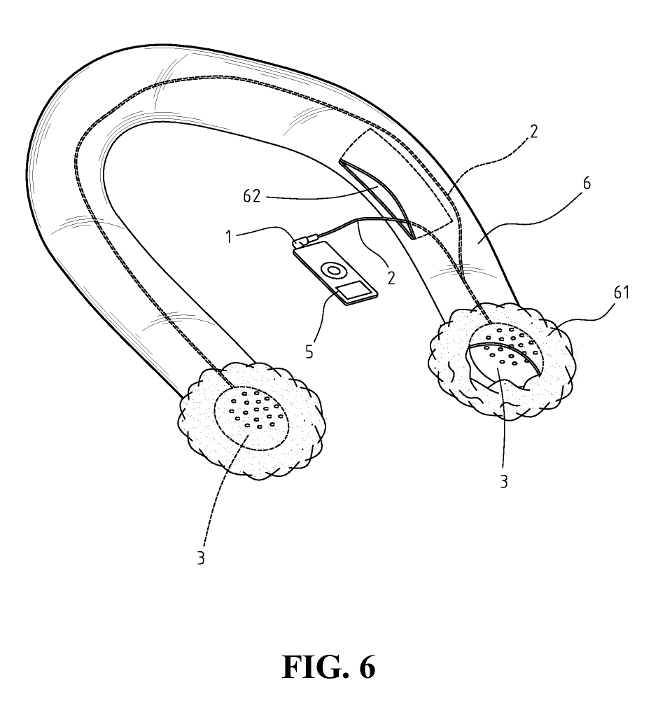

FIG. 6 shows a fourth embodiment of the speaker assembly of the present invention wherein the scarf 6 is a tubular scarf and two decoration members 61 are connected to two ends of the scarf 6. The speakers 3 are enclosed by the decoration members 61 respectively, and the wire 2 connected between the two speakers 3 are also enclosed by the scarf 6. A section of the wire 2 with the plug 1 extends out from an independent space in the scarf 6. The independent space can be a pocket 62 and the music player 5 connected to the plug 1 and the plug 1 and the music player 5 can be received in the pocket 62.

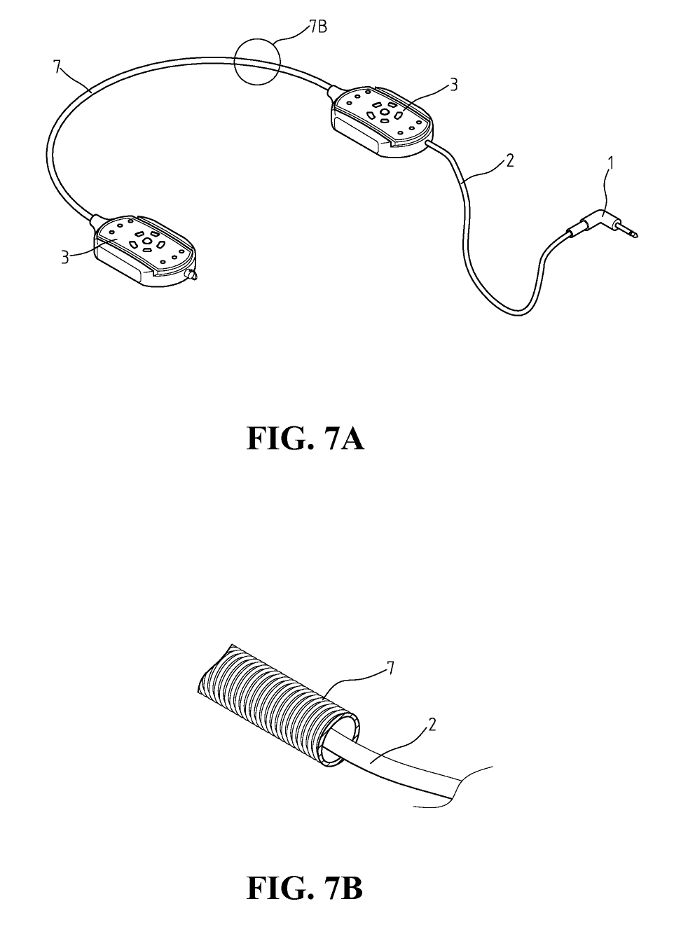

FIG. 7A shows the fifth embodiment of the present invention. The main body of the embodiment includes plug 1, wire 2, and at least two speakers 3. A connector 7 is included between speakers 3. Connector 7 can be a long object that is flexible and can be bended into various shapes. In this embodiment, connector 7 can be a jacketed metal flexible conduit. The jacketed metal flexible conduit can be a stainless steel, aluminum, or electroplated iron sheet wound into a tube and covered with a layer of PVC material. The jacketed metal flexible conduit can be bended into various shapes and readily available in the market. Wire 2 connecting speakers 3 can be hidden inside the hollow tube of connector 7, as shown in FIG. 7B.

However, connector 7 in the fifth embodiment is not limited to the jacketed metal flexible conduit. Other equivalent materials, such as plastic corrugated tubing, metal stripes, including aluminum stripe, copper stripes can also be used, and also within the scope of the present invention. When a metal stripe is used, an additional enclosing layer is required to enclose the metal stripe and wire 2.

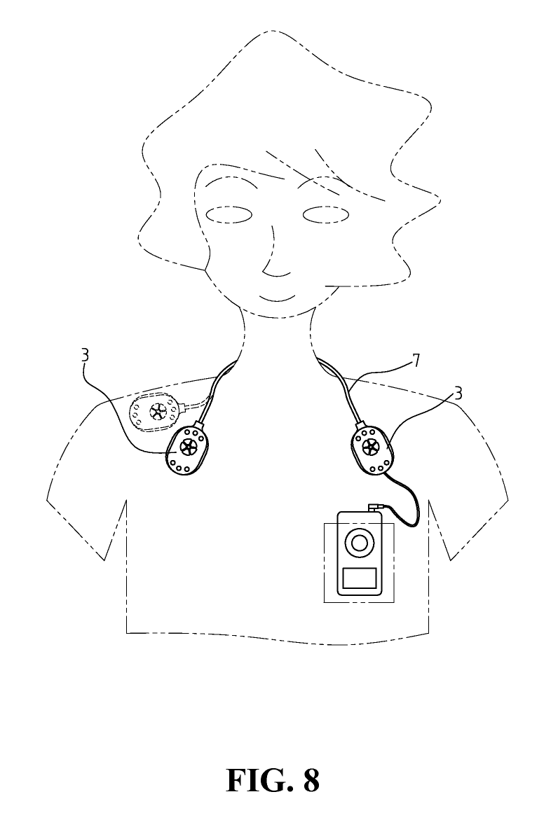

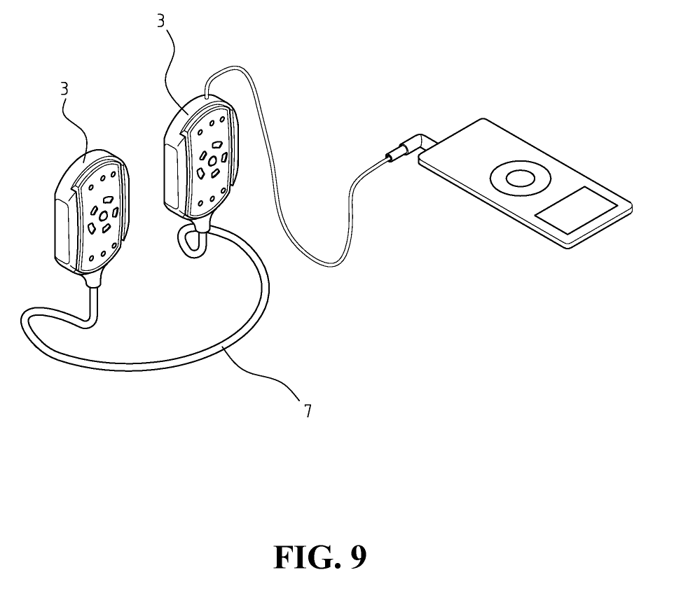

FIG. 8 shows the fifth embodiment applied on a user's neck. When used on the neck of the user, connector 7 is bended to mount on the user's neck and speakers 3 can be placed towards the user's ears, indicated as the dash line in FIG. 8. FIG. 9 shows the fifth embodiment standing alone on a desk. When used standing alone on a desk as a speaker set, connector 7 can also be bended into a shape so that the speaker assembly can stand on the desk. In addition, connector 7 can be bended into other shapes to mount on other objects so that the portable speaker assembly of the present invention can be used in various situations.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A personal speaker assembly, comprising:
a plug, able to plug into a portable player;
at least a speaker; and
a wire, connected to said speaker, one end of said wire is connected to said plug for providing electrical connection between said speaker and said plug.

2. The personal speaker assembly as claimed in claim 1, wherein said wire has a connection member connected thereto a buckle loop, said wire further comprises a buckle to engage said buckle loop to form a necklace hanging around the user's neck.

3. The personal speaker assembly as claimed in claim 1, wherein said wire is a loop including at least a speaker, and said wire extending a segment connecting to said plug.

4. The personal speaker assembly as claimed in claim 1, wherein said speaker is driven by said portable player and does not require additional power supply.

5. The personal speaker assembly as claimed in claim 1, wherein said portable player can be an MP3 player, a CD player, a cassette player, or a radio.

6. The personal speaker assembly as claimed in claim 1, wherein said wire and said speaker are received inside a scarf.

7. The personal speaker assembly as claimed in claim 6, wherein said wire is enclosed by said scarf.

8. The personal speaker assembly as claimed in claim 6, wherein said scarf is a tubular scarf with two ends having decorative members, said decorative members enclose said speaker, and said wire enclosed inside said tubular scarf to connect said speaker.

9. The personal speaker assembly as claimed in claim 8, wherein said scarf further comprises an independent pocket from which said plug and said wire extend out.

10. The personal speaker assembly as claimed in claim 9, wherein said pocket can receive said portable player.

11. A scarf able to play music, comprising:
a plug, able to plug to a portable player;
at least a speaker;
a wire, connected to said speaker, one end of said wire is connected to said plug for providing electrical connection between said speaker and said plug; and
a scarf, enclosing said speaker and said wire.

12. A personal speaker assembly, comprising:
a plug, able to plug to a portable player;
at least two speakers;
a wire, connected to said speaker, one end of said wire is connected to said plug for providing electrical connection between said speakers and said plug; and
a connector, connecting two said speakers and said connector being a long object made of bendable material.

13. The personal speaker assembly as claimed in claim 12, wherein said connector is made of jacketed metal flexible conduits.

14. The personal speaker assembly as claimed in claim 13, wherein said wire is hidden inside said jacketed metal flexible conduit.

15. The personal speaker assembly as claimed in claim 12, wherein said connector is made of plastic corrugated tubings.
